(19) United States
(12) Patent Application Publication
(10) Pub. No.: US 2013/0083123 A1
(43) Pub. Date: Apr. 4, 2013

(54) LIQUID EJECTION APPARATUS AND WIPING METHOD

(71) Applicant: BROTHER KOGYO KABUSHIKI KAISHA, Nagoya-shi (JP)

(72) Inventor: Yuma TANABE, Nagoya-shi, Aichi-ken (JP)

(73) Assignee: BROTHER KOGYO KABUSHIKI KAISHA, Nagoya-shi, Aichi-ken (JP)

(21) Appl. No.: 13/629,500

(22) Filed: Sep. 27, 2012

(30) Foreign Application Priority Data
Sep. 30, 2011 (JP) 2011-218515

(51) Int. Cl. B41J 2/165

(52) U.S. Cl. 347/33

(57) ABSTRACT

A liquid ejection apparatus includes: a head having an ejection face for ejecting liquid; a sealing mechanism which establishes a sealing state in which a sealed space is sealed; a humid-air supply/discharge mechanism which supplies a humid air into the sealed space via an air inlet and discharges the air from the sealed space via an air outlet; and a control device which controls an ejection-face wiper to wipe the liquid from the ejection face by causing its parallel movement with respect to the ejection face in a wiper moving direction directed from a first end area of the ejection face toward its second end area with the ejection-face wiper contacting the ejection face. The air inlet is provided at a position nearer to a downstream end of a moving path of the ejection-face wiper than to an upstream end thereof in the wiper moving direction.

### CROSS REFERENCE TO RELATED APPLICATION

The present application claims priority from Japanese Patent Application No. 2011-218515, which was filed on Sep. 30, 2011, the disclosure of which is herein incorporated by reference in its entirety.

### BACKGROUND OF THE INVENTION

1. Field of the Invention

The present invention relates to a liquid ejection apparatus configured to eject liquid and to a wiping method.

2. Description of the Related Art

There is conventionally known a liquid ejection apparatus including: a liquid ejection head having an ejection face in which ejection openings are formed for ejecting liquid; and a wiper for wiping the liquid from the ejection face.

For example, there is known a liquid ejection apparatus having a wiper and configured to eject ink onto a recording medium to record an image thereon. In this apparatus, a capping mechanism covers an ejection face (a nozzle face) to form an ejection space (a sealed space) isolated from an outside space. A temperature/humidity-adjusted-air supply mechanism supplies an air having adjusted temperature and humidity into the ejection space via an air inlet opening formed in the capping mechanism, whereby condensation occurs on the ejection face, making it possible to moisturize the ink firmly stuck to the ejection face. Thus, the ink firmly stuck to the ejection face can be efficiently removed by wiping of the ejection face by the wiper.

### SUMMARY OF THE INVENTION

However, in this liquid ejection apparatus, when condensation more than desired is caused on the entire ejection face by supplying the air having the adjusted humidity into the ejection space via the air inlet opening, an excessive amount of condensation occurs on an area of the ejection face near the air inlet opening when compared with the other areas. If the wiper wipes the ejection face in this state from the area near the air inlet opening as an upstream side in a wiping direction, a large amount of water of the condensation formed on the area near the air inlet opening is moved with the wiper toward a downstream side in the wiping direction. The water moved with the wiper is mixed with meniscuses of the ink to be ejected from the ejection openings formed on a downstream area of the ejection face in the wiping direction, resulting in an undesirable lowering of an ink density of the meniscuses.

This invention has been developed to provide a liquid ejection apparatus and a wiping method capable of preventing a lowering in a liquid density of meniscuses of liquid formed in ejection openings, when an ejection face is wiped with a wiper.

The present invention provides a liquid ejection apparatus, comprising: a liquid ejection head having an ejection face that has a plurality of ejection openings for ejecting liquid, an ejection space being defined facing the ejection face; a sealing mechanism configured to selectively establish one of (i) a sealing state in which a sealed space including the ejection space is sealed from an outside thereof and (ii) an open state in which the sealed space is open to the outside; an air inlet opening through which an air is introduced into the sealed space in the sealing state; an air outlet opening through which an air is discharged from the sealed space in the sealing state; a humid-air supply/discharge mechanism configured, when the sealing mechanism is in the sealing state, to supply a humid air into the sealed space via the air inlet opening and discharge the air in the sealed space from the air outlet opening; an ejection-face wiper configured to wipe the ejection face; and a control device configured to control the ejection-face wiper to perform the wiping of the liquid from the ejection face by causing parallel movement of the ejection-face wiper with respect to the ejection face in a wiper moving direction directed from a first end area of the ejection face toward a second end area thereof in a state in which the ejection-face wiper is held in contact with the ejection face, wherein the air inlet opening is provided at a position nearer to a downstream end of a moving path of the ejection-face wiper moved by the control device than to an upstream end of the moving path in the wiper moving direction.

The present invention provides a wiping method for wiping an ejection face of a liquid ejection apparatus, the ejection face having a plurality of ejection openings for ejecting liquid, an ejection space being defined facing the ejection face, the liquid ejection apparatus comprising: a sealing mechanism configured to selectively establish one of (i) a sealing state in which a sealed space including the ejection space is sealed from an outside thereof and (ii) an open state in which the sealed space is open to the outside; an air inlet opening through which an air is introduced into the sealed space in the sealing state; an air outlet opening through which an air is discharged from the sealed space in the sealing state; a humid-air supply/discharge mechanism configured, when the sealing mechanism is in the sealing state, to supply a humid air into the sealed space via the air inlet opening and discharge the air in the sealed space from the air outlet opening; and an ejection-face wiper configured to wipe the liquid from the ejection face, the wiping method comprising: wiping the liquid from the ejection face by causing parallel movement of the ejection-face wiper with respect to the ejection face in a direction directed toward the air inlet opening in a state in which the ejection-face wiper is held in contact with the ejection face, wherein the air inlet opening is provided at a position nearer to a downstream end of a moving path of the moved ejection-face wiper than to an upstream end of the moving path in the wiper moving direction.

In the liquid ejection apparatus and the wiping method as described above, the moving direction of the ejection-face wiper is a direction directed toward an area of the ejection face on which a larger amount of condensation is formed. Thus, it is possible to prevent water of the condensation formed on the ejection face from flowing into meniscuses of the liquid formed in the ejection openings located on a downstream side in the wiper moving direction, thereby preventing a lowering of the liquid density of the meniscuses.

### BRIEF DESCRIPTION OF THE DRAWINGS

The objects, features, advantages, and technical and industrial significance of the present invention will be better understood by reading the following detailed description of the embodiments of the invention, when considered in connection with the accompanying drawings, in which:

FIG. 1 is a side view generally showing an overall construction of an ink-jet printer as a first embodiment of the present invention;

FIGS. 2A-2C are views each showing a situation for explaining operations of a platen and a facing member;

FIG. 3A is a view showing a situation for explaining operations of a wiper unit and the facing member in a humidifying operation, FIG. 3B is a view showing a situation for explaining operations of the wiper unit and the facing member in a head wiping, FIG. 3C is a view showing a situation for explaining operations of the wiper unit and the facing member in a facing-face wiping, and FIG. 3D is a graph representing a relationship between a viscosity of ink on the facing face and an ink wiping performance;

FIG. 4 is a plan view showing a channel unit and actuator units of a liquid ejection head of the printer in FIG. 1;

FIG. 5A is an enlarged view showing an area VA enclosed by one-dot chain line in FIG. 4, and FIG. 5B is a partial cross-sectional view taken along line VB-VB in FIG. 5A;

FIG. 6 is a view for explaining a humid-air supply/discharge mechanism;

FIG. 7 is a partial cross-sectional view showing an area VII enclosed by one-dot chain line in FIG. 6;

FIG. 8 is a block diagram showing an electric configuration of a controller shown in FIG. 1;

FIG. 9A is a flow-chart showing a maintenance controlled by the controller in the first embodiment, and FIG. 9B is a flow-chart showing maintenance controlled by the controller in a second embodiment; and

FIGS. 10A and 10B are views each for explaining a humid-air supply/discharge mechanism in the second embodiment of the present invention, and FIG. 10C is a view for explaining a humid-air supply/discharge mechanism in a third embodiment of the present invention.

### DETAILED DESCRIPTION OF THE EMBODIMENTS

Hereinafter, there will be described an ink-jet printer as one example of a liquid ejection apparatus as embodiments of the present invention by reference to the drawings.

### First Embodiment

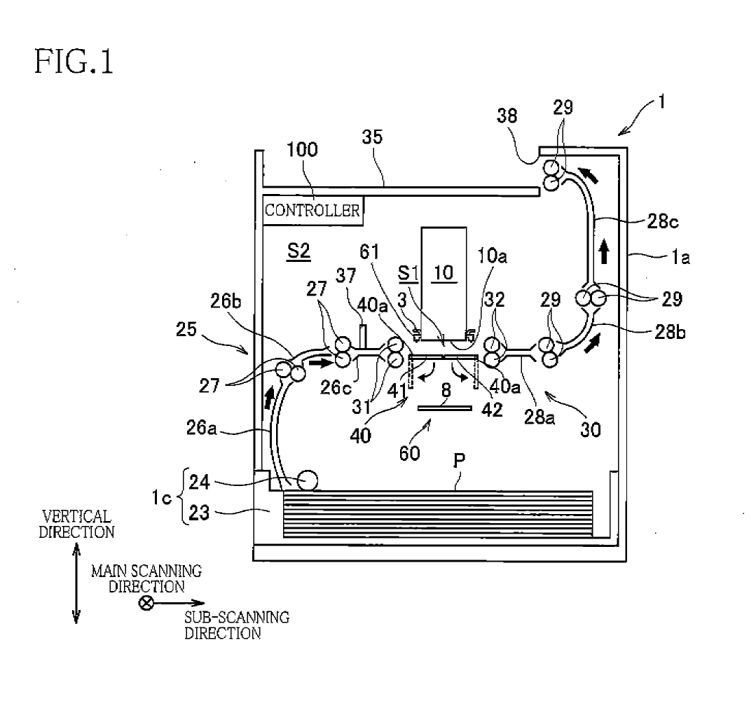

First, there will be explained an overall construction of an ink-jet printer 1 as a first embodiment of the present invention with reference to FIG. 1.

The printer 1 includes a housing 1a having a rectangular parallelepiped shape. A sheet-discharge portion 35 is provided on an upper portion of a top plate of the housing 1a. In a space defined by the housing 1a, a sheet conveyance path is formed through which a recording medium in the form of a sheet P is conveyed from a sheet-supply unit 1c which will be described below toward the sheet-discharge portion 35 along bold arrows shown in FIG. 1.

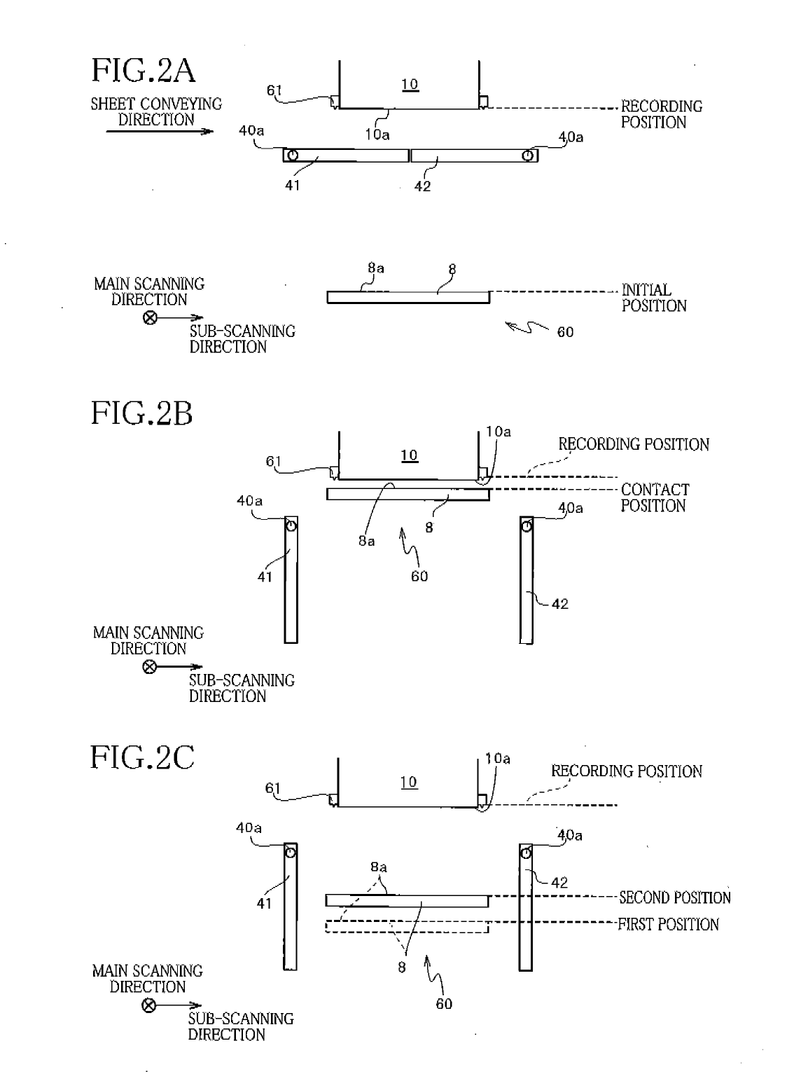

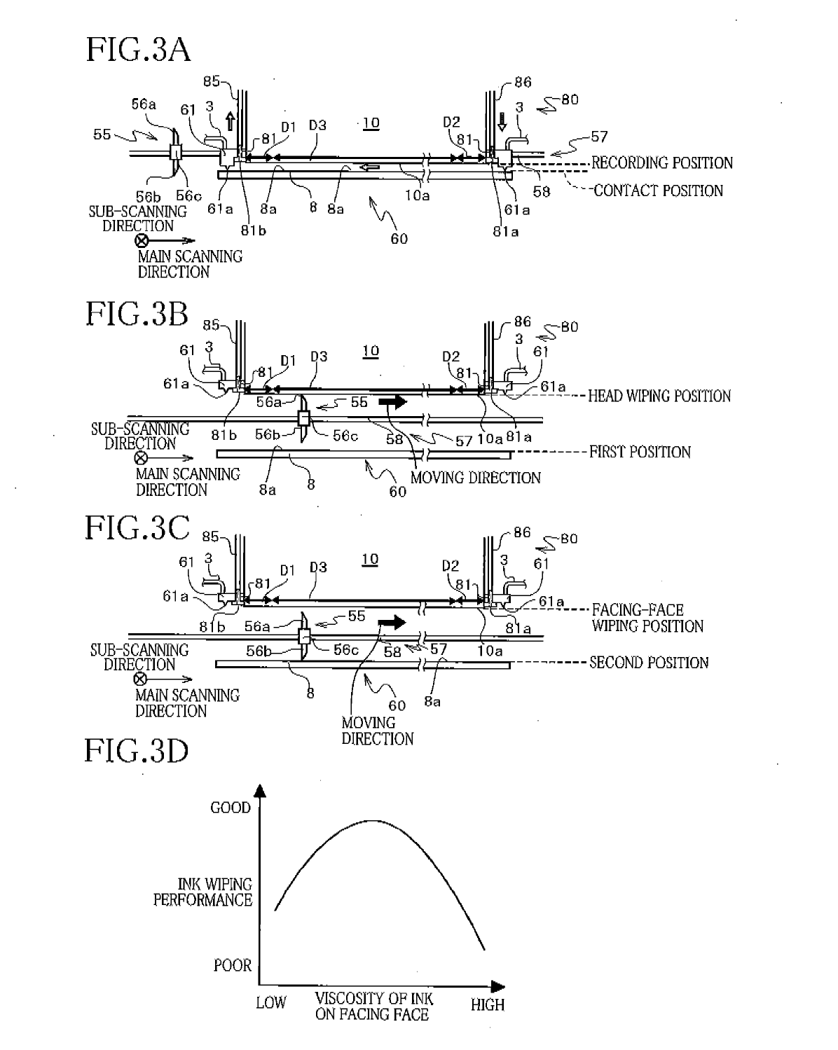

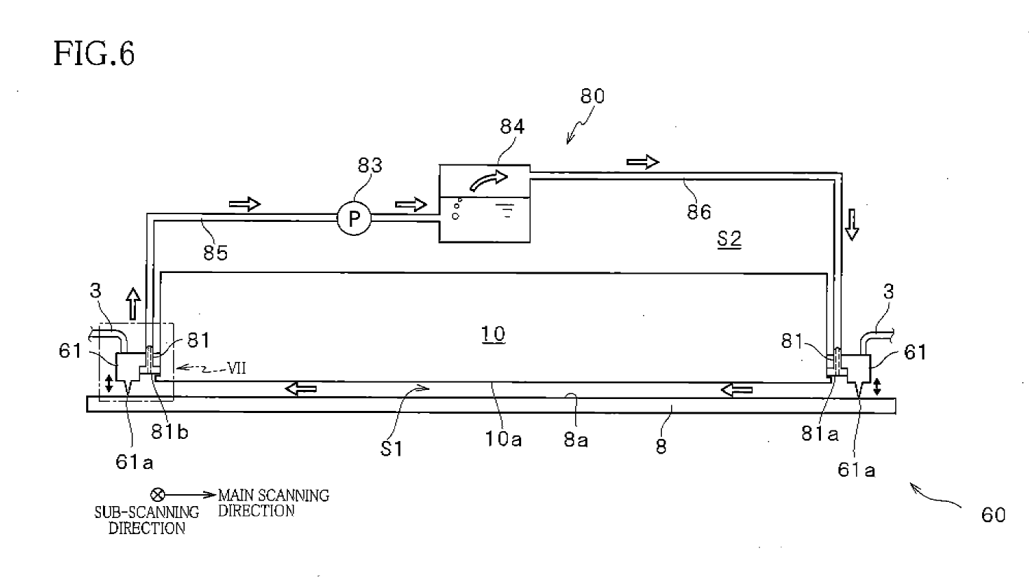

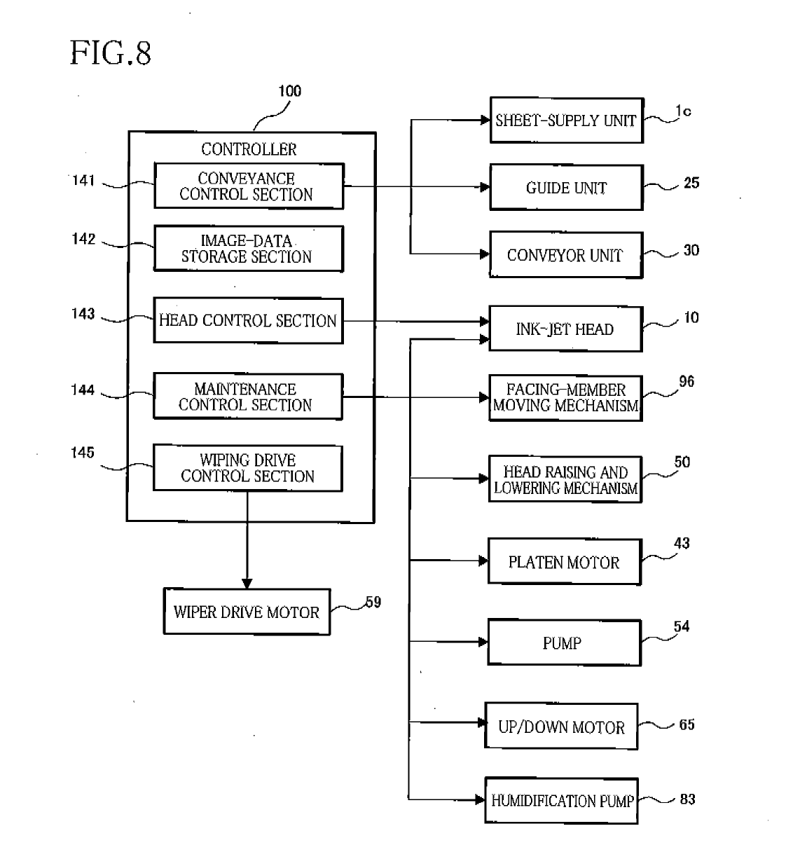

The housing 1a accommodates: a head 10 as one example of a liquid ejection head; a conveyor unit 30 for conveying the sheet P; a platen 40 for supporting the sheet P in image recording at a facing position (see FIG. 2A) at which the platen 40 faces an ejection face 10a of the head 10; a guide unit 25 for guiding the sheet P; a cartridge, not shown, storing black ink to be supplied into the head 10; a head raising and lowering mechanism 50 (see FIG. 8); a wiper unit 55 (see FIG. 3); a capping mechanism 60 as one example of a sealing mechanism; a humid-air supply/discharge mechanism 80 (see FIG. 6); a facing-member moving mechanism 96 (see FIG. 8); a controller 100 configured to control operations of components of the printer 1; and so on. It is noted that the cartridge is connected to the head 10 via a tube, not shown, and a pump 54 (see FIG. 8).

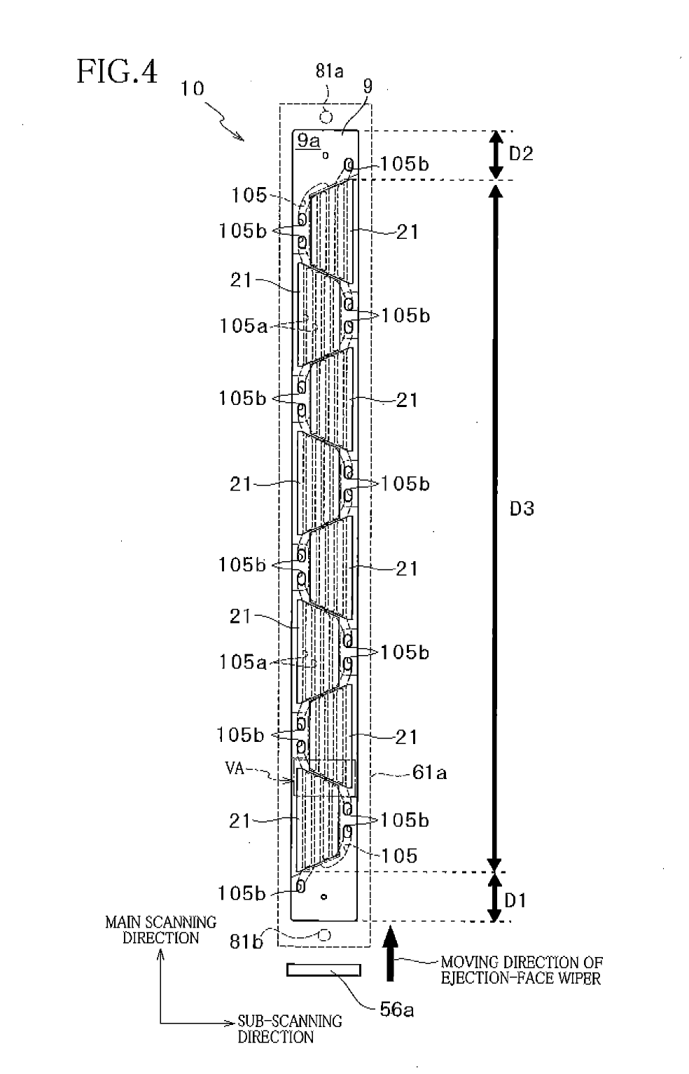

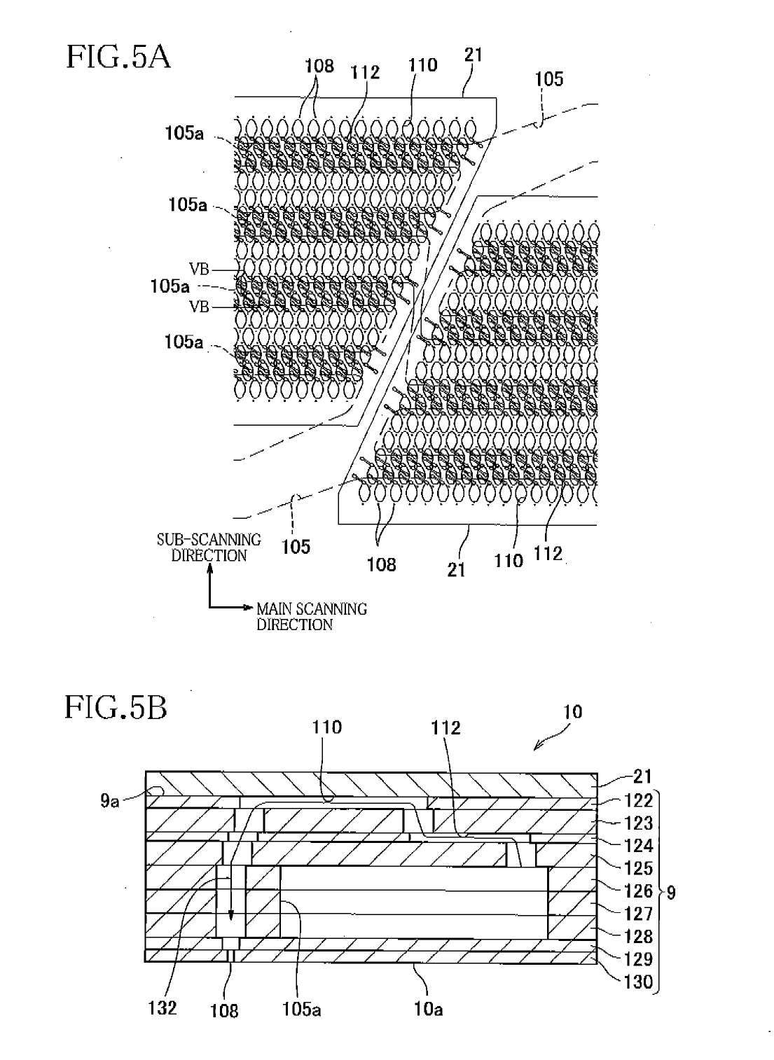

The head 10 is a line head having a generally rectangular parallelepiped shape elongated in a main scanning direction. A lower face of the head is the ejection face 10a having a multiplicity of ejection openings 108 (see FIG. 5) opening therein. The black ink is ejected from the ejection openings 108 in the image recording. As shown in FIG. 4, the ejection face 10a includes: an ejection-opening formed area D3 in which the ejection openings 108 are formed; and a pair of no-ejection-opening formed areas D1, D2 in each of which the ejection openings 108 are not formed. The ejection-opening formed area D3 is interposed between the pair of no-ejection-opening formed areas D1, D2 in the main scanning direction.

The head 10 is supported by the housing 1a via a head holder 3. The head holder 3 holds the head 10 such that a predetermined space suitable for the recording is formed between the ejection face 10a and an upper face of the platen 40. Constructions of the head holder 3 and the head 10 will be explained below in more detail.

The conveyor unit 30 includes nip rollers 31, 32 disposed on opposite sides of the platen 40 in a sheet conveying direction. Each of the nip rollers 31, 32 includes a pair of rollers opposed to each other so as to nip the sheet P in an up and down direction. Each of the nip rollers 31, 32 applies a conveying power to the sheet P to convey the nipped sheet P in the conveying direction. The nip roller 31 is located upstream of the nip roller 32 in the sheet conveying direction. The sheet P to which the nip roller 31 has applied the conveying power is conveyed in the sheet conveying direction while being supported on the upper face of the platen 40. The sheet P having passed through the upper face of the platen 40 receives the conveying power generated by the nip roller 32 and is conveyed from the platen 40 toward a downstream side thereof in the sheet conveying direction.

The platen 40 is constituted by a pair of door members 41, 42 and openably supported by a pair of rotation shafts 40a located on opposite sides of the ejection face 10a in plan view and extending in the main scanning direction in parallel with the ejection face 10a. The pair of door members 41, 42 are rotated about the respective rotation shafts 40a by a platen motor 43 (see FIG. 8), whereby the platen 40 is selectively positioned at one of a facing position (see FIG. 2A) at which the platen 40 is in parallel with a horizontal plane so as to face the ejection face 10a and a non-facing position (see FIGS. 2B and 2C) at which the platen 40 extends downward so as not to face the ejection face 10a. The platen 40 is positioned at the non-facing position in maintenance and positioned at the facing position in the image recording. When the platen 40 is positioned at the facing position, a distance between the ejection face 10a and the platen 40 is less than a distance between the ejection face 10a and a facing member 8. The upper face of the platen 40 which faces the ejection face 10a when the platen 40 is positioned at the facing position is a support face for supporting the sheet P, and a material and a processing for this support face are selected and employed so as to reliably support the sheet P. For example, a silicon layer having a low viscosity is formed on the support face, and a multiplicity of ribs are formed on the support face in the sub-scanning direction, preventing floating and the like of the sheet P placed on the support face. The platen 40 is formed of a resin material.

The guide unit 25 includes an upstream-side guide portion and a downstream-side guide portion arranged opposite sides of the conveyor unit 30. The upstream-side guide portion includes three guides 26a, 26b, 26c and two pairs of conveyor rollers 27. The upstream-side guide portion connects between the sheet-supply unit 1c and the conveyor unit 30. The downstream-side guide portion includes three guides 28a, 28b, 28c and three pairs of conveyor rollers 29. The downstream-side guide portion connects between the conveyor unit 30 and the sheet-discharge portion 35.

The sheet-supply unit 1c includes a sheet-supply tray 23 as one example of an accommodating portion and a sheet-supply roller 24. The sheet-supply tray 23 can be mounted on and removed from the housing 1a in the sub-scanning direction. The sheet-supply tray 23 has a box-like shape opening upward and can accommodate the sheets P. The sheet-supply roller 24 is rotated by the control of the controller 100 to supply an uppermost one of the sheets P in the sheet-supply tray 23. Here, the sub-scanning direction is a direction parallel to the sheet conveying direction in which the conveyor unit 30 conveys the sheet P (i.e., a right and left direction in FIG. 1), and the main scanning direction is a direction parallel to the horizontal plane in FIG. 1 and perpendicular to the sub-scanning direction.

The controller 100 controls the components of the printer 1 to control the operations of the printer 1. The controller 100 controls the image recording based on a recording command supplied from an external device such as a PC connected to the printer 1. Specifically, the controller 100 controls operations such as the conveyance operation of the sheet P and the ink ejecting operation synchronized with the conveyance of the sheet P. The sheet P supplied from the sheet-supply tray 23 by the conveyance operation controlled by the controller 100 is conveyed to the conveyor unit 30 by the conveyor-roller pairs 27 while being guided by the guides 26a, 26b, 26c. The conveyor unit 30 conveys the sheet P to the space between the head 10 and the platen 40. When the sheet P conveyed to the space between the head 10 and the platen by the conveyor unit 30 passes through a position just under the head 10 in the sub-scanning direction, the ink is ejected from the ejection openings 108 in order to form a monochrome image on the sheet P. The ink is ejected from the ejection openings 108 under the control of the controller 100 based on a detection signal outputted from a sheet sensor 37. The sheet P is then conveyed upward by the conveyor roller pairs 29 while being guided by the guides 28a, 28b, 28c and then discharged onto the sheet-discharge portion 35 through an opening 38 formed in an upper portion of the housing 1a.

Further, the controller 100 executes a control to perform the maintenance for maintaining or recovering ink ejection characteristics of the head 10. The maintenance includes a humidifying operation, a discharge operation, and a wiping operation. As shown in FIG. 6, the humidifying operation is an operation for supplying a humid air into a sealed space S1 and discharging an air existing in the sealed space S1 into an outside space S2. Here, the sealed space S1 is a space including an ejection space facing the ejection face 10a, and the sealed space S1 is defined by an annular member 61 of the capping mechanism 60 which will be described below, the facing member 8, and the ejection face 10a when a distal end 61a of the annular member 61 is held in contact with the facing member 8. The humidifying operation is performed when the printer 1 is stopped or at rest, for example.

The discharge operation includes flushing and purging. The flushing is an operation for driving actuators of the head 10 based on flushing data different from image data to forcibly eject the ink from some or all of the ejection openings 108. The purging is an operation in which the pump 54 (see FIG. 8) applies pressures to the ink in the head 10 to forcibly eject the ink from all the ejection openings 108. The flushing is performed after the humidifying operation, for example.

The wiping operation includes: a head wiping for wiping the ink from the ejection face 10a with the wiper unit 55; and a facing-face wiping for wiping the ink from a facing face 8a of the facing member 8 with the wiper unit 55. This wiping operation is performed after the discharge operation, for example.

As shown in FIG. 3, the wiper unit 55 includes: an ejection-face wiper 56a; a facing-face wiper 56b; a base portion 56c for supporting these wipers; and a wiper moving mechanism 57. The ejection-face wiper 56a is a plate-like, elastic member (for example, formed of rubber) slightly longer than the ejection face 10a in the sub-scanning direction. Likewise, the facing-face wiper 56b is a plate-like elastic member slightly longer than the facing member 8 in the sub-scanning direction. The base portion 56c has a rectangular parallelepiped shape elongated in the sub-scanning direction, and circular cylindrical holes are respectively formed in opposite ends of the base portion 56c in its longitudinal direction. These holes are formed through the base portion 56c in the main scanning direction. A female thread is formed on an inner face of one of these holes. The wiper moving mechanism 57 is constituted by: two guides 58 arranged in the sub-scanning direction; and a wiper drive motor 59 (see FIG. 8) for applying a rotational power to one of the two guides 58. This guide 58 is a round rod provided upstream of the head 10 in the sheet conveying direction so as to extend in the main scanning direction. A male thread is formed on an outer circumferential face of this guide 58 for receiving the rotational power transmitted from the wiper drive motor 59. This guide 58 extends through the hole of the base portion 56c in a state in which the thread of the guide 58 and the hole of the base portion 56c are fitted to each other. The other guide 58 is a round rod having no male thread in its outer circumferential face and extending through the other hole of the base portion 56c in which no female thread is formed on its inner face.

Forward and reverse rotations of the wiper drive motor 59 reciprocate the base portion 56c along the guides 58. The guide 58 having no male thread on its outer circumferential face inhibits the rotation of the base portion 56c. As shown in FIG. 3A, a vicinity of a left end portion of the head 10 in the main scanning direction is a wait position of the base portion 56c. In the head wiping and the facing-face wiping, the base portion 56c is moved in a direction (moving direction) directed from the no-ejection-opening formed area D1 (as one example of a first area) as one end portion of the ejection face 10a in the main scanning direction toward a no-ejection-opening formed area D2 (as one example of a second area) as the other end portion of the ejection face 10a in the main scanning direction, that is, the base portion 56c is moved rightward in FIG. 3A. As a result, in the head wiping, the ink on the ejection face 10a is removed by the ejection-face wiper 56a, and, in the facing-face wiping, the ink on the facing face 8a of the facing member 8 is removed by the facing-face wiper 56b.

It is noted that an upstream end of a moving path (locus) of the ejection-face wiper 56a in the head wiping is located in any of a space facing the no-ejection-opening formed area D1 and a space located upstream of the no-ejection-opening formed area D1 in a direction directed from the no-ejection-opening formed area D1 toward the no-ejection-opening formed area D2. Further, a downstream end of the moving path of the ejection-face wiper 56a in the head wiping is located in any of a space facing the no-ejection-opening formed area D2 and a space located downstream of the no-ejection-opening formed area D2 in a direction directed from the no-ejection-opening formed area D1 toward the no-ejection-opening formed area D2. In other words, an air inlet opening 81a which will be described below is formed in a position nearer to the downstream end of the moving path of the ejection-face wiper 56a in the head wiping than to the upstream end of the moving path in the moving direction of the ejection-face wiper 56a. Further, the air outlet opening 81b which will be described below is formed in a position nearer to the upstream end of the moving path of the ejection-face wiper 56a in the head wiping than to the downstream end of the moving path in the moving direction of the ejection-face wiper 56a.

The head raising and lowering mechanism 50 is configured to move the head holder 3 in a vertical direction to move the head 10 selectively to one of a recording position, a head wiping position, and a facing-face wiping position. At the recording position shown in FIG. 1, the head 10 faces the platen 40 at the distance suitable for the recording. The head wiping position as shown in FIG. 3B is located above the recording position in the vertical direction and is a position at which the head is positioned in the head wiping. The facing-face wiping position as shown in FIG. 3C is located above the head wiping position and is a position at which the head 10 is disposed in the facing-face wiping.

As shown in FIG. 3B, when the head 10 is positioned at the head wiping position, the ejection face 10a is located slightly below an upper end of the ejection-face wiper 56a. As shown in FIG. 3C, when the head 10 is positioned at the facing-face wiping position, the ejection face 10a is located above the upper end of the ejection-face wiper 56a.

There will be next explained the head 10 in detail with reference to FIGS. 4, 5A, and 5B. In FIG. 5A, pressure chambers 110, apertures 112, and the ejection openings 108 are illustrated by solid lines for easier understanding purposes though these elements are located under actuator units 21 and thus should be illustrated by broken lines. As shown in FIG. 4, the head 10 is a stacked body including a channel unit 9 and the eight actuator units 21 fixed to an upper face of the channel unit 9. A lower face of the channel unit 9 is the ejection face 10a. Ink channels are formed in the channel unit 9, and the actuator units 21 apply ejection energies to the ink in these channels.

As shown in FIG. 5B, the channel unit 9 is a stacked body constituted by nine metal plates 122-130 formed of stainless steel stacked on one another. As shown in FIG. 4, the upper face of the channel unit 9 has eighteen ink supply openings 105b opening therein so as to communicate with a reservoir unit. As shown in FIGS. 4, 5A, and 5B, manifold channels 105 and sub-manifold channels 105a are formed in the channel unit 9. Each of the ink supply openings 105b communicates with a corresponding one of the manifold channels 105, and each of the sub-manifold channels 105a is branched from a corresponding one of the manifold channels 105. Further, in the channel unit 9 are also formed individual ink channels 132 each extending from a corresponding one outlet of the sub-manifold channels 105a to a corresponding one of the ejection openings 108 via a corresponding one of the pressure chambers 110. The ejection openings 108 formed in the ejection face 10a are arranged in matrix so as to be spaced from one another in the main scanning direction (as one example of one direction) at a resolution of 600 dpi in the main scanning direction.

As shown in FIGS. 4, 5A, and 5B, the ink supplied from the reservoir unit into the ink supply openings 105b flows into the manifold channels 105 and the sub-manifold channels 105a. The ink in the sub-manifold channels 105a is distributed into the individual ink channels 132 and flows to the ejection openings 108 through the respective apertures 112 and the respective pressure chambers 110.

There will be next explained the actuator units 21. As shown in FIG. 4, each of the eight actuator units 21 has a trapezoid shape in plan view, and these actuator units 21 are arranged in a staggered configuration in the main scanning direction so as not to overlap the ink supply openings 105b. Further, parallel sides of each of the actuator units 21 extend in the main scanning direction, and adjacent two oblique lines of the actuator units 21 overlap each other in the sub-scanning direction.

There will be next explained structures of the head holder 3 and the capping mechanism 60 with reference to FIGS. 4, 6, and 7. The head holder 3 is a frame formed of metal, for example, and supports side faces of the head 10 in its entire perimeters. The annular member 61 of the capping mechanism 60 is provided around the head 10. The annular member 61 is mounted on the head holder 3 so as to enclose an outer circumferential face of the head 10 in plan view. Further, a pair of joints 81 are mounted on the head holder 3. Here, contact portions of the head holder 3 and the head 10 are sealed by a sealant in their entire perimeters. Further, contact portions of the head holder 3 and the annular member 61 are fixed by an adhesive in their entire perimeters.

The pair of joints 81 respectively function as one and the other ends of a circulation channel of the humid-air supply/discharge mechanism 80. As shown in FIG. 6, the pair of joints 81 are constituted by a right joint 81 having the air inlet opening 81a and a left joint 81 having the air outlet opening 81b and disposed on opposite sides of the head 10 in the main scanning direction. That is, as shown in FIG. 3B, the air inlet opening 81a is provided at the downstream end of the moving path of the ejection-face wiper 56a in the head wiping, and the air outlet opening 81b is provided at the upstream end of the moving path of the ejection-face wiper 56a in the head wiping. Thus, the air inlet opening 81a is formed downstream of all the ejection openings 108 in the direction directed from the no-ejection-opening formed area D1 toward the no-ejection-opening formed area D2 of the ejection face 10a. Further, the air outlet opening 81b is formed upstream of all the ejection openings 108 in the direction directed from the no-ejection-opening formed area D1 toward the no-ejection-opening formed area D2 of the ejection face 10a. Thus, in the humidifying operation, the humidified air flows in the direction directed from the no-ejection-opening formed area D2 toward the no-ejection-opening formed area D1 of the ejection face 10a, making it possible to efficiently lower a viscosity of the ink near all the ejection openings 108.

Each of the joints 81 has a generally cylindrical shape and includes a basal end portion 81x and a distal end portion 811y extending from the basal end portion 81x. A circular cylindrical hollow space 81z is formed through the basal end portion 81x and the distal end portion 81y in the vertical direction. The basal end portion 81x and the distal end portion 81y have different outside diameters from each other, specifically, the basal end portion 81x has a greater outside diameter than that of the distal end portion 81y. The hollow space 81z has a uniform diameter along the vertical direction.

The head holder 3 has through holes 3a each having a round shape in plan view. Each of the joints 81 is fixed to the head holder 3 in a state in which the distal end portion 81y is fitted in a corresponding one of the through holes 3a. The distal end portion Sly is smaller than the through hole 3a, but a space formed therebetween is filled with a sealant or other similar substances.

The capping mechanism 60 includes: the annular member 61; an up/down motor 65 (see FIG. 8) for moving a movable member 63 of the annular member 61 upward and downward; the facing member 8; and the facing-member moving mechanism 96 (see FIG. 8) for moving the facing member 8 upward and downward.

The facing member 8 is a glass plate having a rectangular planar shape which is one size larger than the annular member 61 in plan view. It is noted that a material of the facing member 8 is not limited to a glass and may be any other suitable material.

The facing-member moving mechanism 96 is controlled by the controller 100 so as to move the facing member 8 upward or downward selectively to one of an initial position, a first position, a second position, and a contact position.

Here, the initial position, as shown in FIG. 2A, is a position at which an upper face of the facing member 8 is positioned in the image recording. As shown in FIG. 2C, the first position is a position located above the initial position and nearer to the ejection face 10a than the initial position. The head wiping and the purging are performed when the facing member 8 is positioned at this first position. As shown in FIG. 2C, the second position is a position located slightly above the first position and a lower end of the facing-face wiper 56b of the wiper unit 55. The facing-face wiping is performed when the facing member 8 is positioned at this second position.

As shown in FIGS. 2B and 3A, the contact position is a position above the second position. When the movable member 63 of the annular member 61 is moved downward in a state in which the facing member 8 is positioned at this contact position, the distal end 61a of the annular member 61 is brought into contact with the facing member 8, so that the sealed space S1 is sealed or isolated from the outside space S2 (see FIG. 3A). The flushing is performed when the facing member 8 is positioned at this contact position.

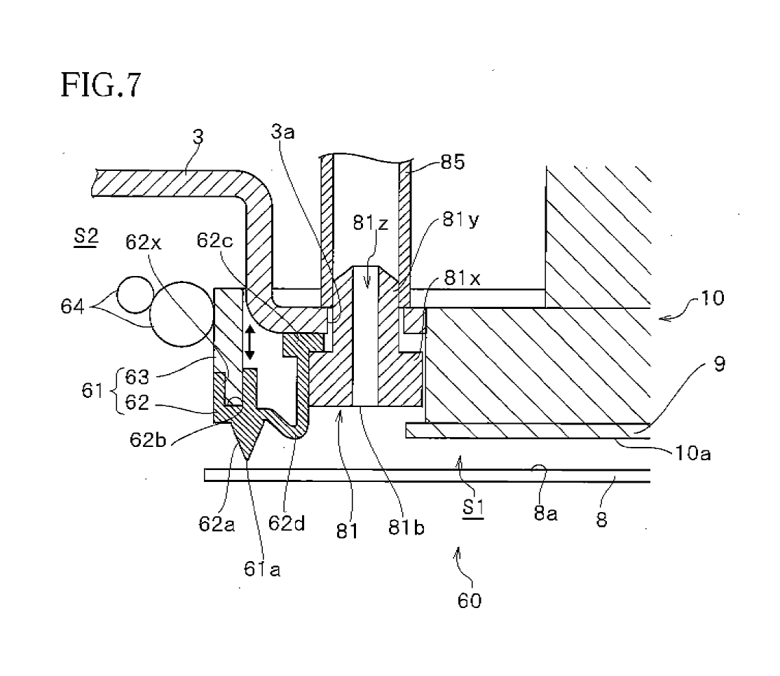

The annular member 61 has a rectangular shape elongated in the main scanning direction and encloses the outer circumferential face of the head 10 in plan view. As shown in FIG. 7, the annular member 61 includes: an elastic member 62 supported by the head holder 3; and the movable member 63 movable upward and downward.

The elastic member 62 is an annular member formed of an elastic material such as rubber and encloses the head 10 in plan view. As shown in FIG. 7, the movable member 62 includes: a base portion 62x; a projecting portion 62a projecting from a lower face of the base portion 62x; a fixed portion 62c fixed to the head holder 3; and a connecting portion 62d connecting between the base portion 62x and the fixed portion 62c. The projecting portion 62a has a triangle shape in its cross section. The fixed portion 62c has a T-shape in its cross section. An upper end portion of the fixed portion 62c is fixed to the head holder 3 by an adhesive or the like. The fixed portion 62c is supported by and between the head holder 3 and the basal end portion 81x of each of the joints 81. The connecting portion 62d curves from a lower end of the fixed portion 62c so as to extend toward an outside (i.e., in a direction away from the ejection face 10a in plan view) and is connected to a side face of a lower portion of the base portion 62x. The connecting portion 62d is deformed by the upward and downward movement of the movable member 63. A recessed portion 62b is formed in an upper face of the base portion 62x. A lower end of the movable member 63 is fitted in this recessed portion 62b.

The movable member 63 is an annular member formed of a rigid material such as a stainless steel and encloses the outer circumferential face of the head in plan view. The movable member 63 is supported by the elastic member 62 so as to be movable relative to the head holder 3 in the vertical direction. The movable member 63 is connected to a plurality of gears 64. When the up/down motor 65 (see FIG. 8) is driven by the controller 100, the gears 64 are rotated, which moves the movable member 63 upward or downward. The base portion 62x is also moved upward or downward in this movement. As a result, a position of the distal end 61a of the annular member 61 (the projecting portion 62a) relative to the ejection face 10a is changed in the vertical direction.

With the upward or downward movement of the movable member 63, the annular member 61 is selectively positioned at one of a capping position (see FIG. 6) at which the distal end 61a is held in contact with the facing face 8a of the facing member 8 located at the contact position and a distant position (see FIG. 7) at which the distal end 61a is distant from the facing face 8a of the facing member 8 located at the contact position. At the capping position, a sealing state is established in which the sealed space S1 is sealed or isolated from the outside space S2 by the annular member 61, the ejection face 10a, and the facing member 8. At the distant position, an open state is established in which the sealed space S1 is open to the outside space S2.

There will be next explained a structure of the humid-air supply/discharge mechanism 80 with reference to FIG. 6. As shown in FIG. 6, the humid-air supply/discharge mechanism 80 includes the pair of joints 81, a humidification pump 83, a tank 84, tubes 85, 86, and so on. One end of the tube 85 is fitted on the distal end portion 81y of the left joint 81, and the other end thereof is connected to the tank 84. One end of the tube 86 is fitted on the distal end portion 81y of the right joint 81, and the other end is connected to the tank 84. That is, the tubes 85, 86 establish a communication between the sealed space S1 and the tank 84.

The tank 84 stores water (i.e., humidification liquid) in its lower space and stores, in its upper space, the air humidified by the water stored in the lower space. The tube 85 communicates with the lower space of the tank 84 (below a water surface), while the tube 86 communicates with the upper space of the tank 84. It is noted that a check valve, not shown, is provided in the tube 85 for inhibiting the water in the tank 84 from flowing into the tube 85, resulting in that the air flows only in a direction indicated by while arrows in FIG. 6.

When the humidifying operation is performed, the controller 100 drives the up/down motor 65 to move the annular member 61 to the capping position so as to establish the sealing state of the sealed space S1. The controller 100 then drives the humidification pump 83 to circulate the air in the tank 84 along the white arrows as shown in FIG. 6. The humid air in the upper space is supplied from the air inlet opening 81a into the sealed space S1. Since the sealed space S1 is in the sealing state at this time, the air in the sealed space S1 flows toward the air outlet opening 81b while being replaced with the humid air. Since the tube 85 communicates with the water in the tank 84 below the water surface, the air in the sealed space S1 is humidified in the tank 84. The generated humid air is supplied into the sealed space S1 during the driving of the humidification pump 83. As a result of this humidifying operation, the viscosity of the ink near all the ejection openings 108 can be lowered. In this operation, the humid air supplied from the air inlet opening 81a causes condensation on the ejection face 10a and the facing face 8a. As a result, the ink firmly stuck to the ejection face 10a and the facing face 8a can be moisturized, making it possible for the head wiping and the facing-face wiping in this state to efficiently remove the ink firmly stuck to the ejection face 10a and the facing face 8a. It is noted that the humid air supplied from the air inlet opening 81a may not cause the condensation on the ejection face 10a and the facing face 8a under some environmental conditions.

Here, when the humidifying operation is performed as described above, the ink to be ejected from the ejection openings 108 and water content of the humid air are mixed with each other at meniscuses of the ink in the ejection openings 108, which lowers an ink density of the meniscuses. In order to solve this problem, in the present embodiment, when the image recording is performed after the humidifying operation, the flushing is performed to discharge the ink whose density has been lowered, and then the head wiping and the facing-face wiping are performed to remove the ink ejected by the flushing and remaining on the ejection face 10a and the facing face 8a.

Incidentally, an amount of the condensation on the ejection face 10a and an amount of the condensation on the facing face 8a are relatively large at an area near the air inlet opening 81a and decrease with increases in distance from the air inlet opening 81a. Thus, when the viscosity of the ink near all the ejection openings 108 is lowered to a desired viscosity or when condensation more than desired is caused on the entire ejection face 10a and the entire facing face 8a in order to moisturize the ink firmly stuck to the ejection face 10a and the facing face 8a, an excessive amount of condensation occurs on areas of the ejection face 100a and the facing face 8a near the air inlet opening 81a, e.g., the no-ejection-opening formed area D2, when compared with the other areas.

Thus, if the head wiping is performed from the area of the ejection face 10a on which the excessive amount of condensation is formed, that is, the ejection-face wiper 56a wipes the ejection face 10a from the area as an upstream side in the moving direction of the ejection-face wiper 56a, a large amount of water flows into the meniscuses of the ink formed in the ejection openings 108 located downstream of this area in the moving direction of the ejection-face wiper 56a, resulting in a lowering of the ink density of the meniscuses. In this case, the flushing has to be performed again unfortunately. In order to solve this problem, in the present embodiment, as described above, the air inlet opening 81a is formed at the downstream end of the moving path of the ejection-face wiper 56a in the head wiping. That is, the moving direction of the ejection-face wiper 56a in the head wiping is a direction directed toward the area of the ejection face 10a on which the larger amount of the condensation is formed. Thus, it is possible to prevent the water of the excessive condensation formed on the ejection face 10a from flowing into the meniscuses of the ink formed in the ejection openings 108, thereby preventing the lowering of the ink density of the meniscuses.

Regarding the facing-face wiping, as shown in FIG. 3D, the viscosity of the ink on the facing face 8a has a suitable viscosity range that provides a good ink wiping performance of the facing-face wiper 56b. Specifically, if an amount of the water content of the ink on the facing face 8a is small, and the viscosity of the ink is too high, the ink is firmly stuck to the facing face 8a, providing a poor wiping performance. On the other hand, if the amount of the water content of the ink on the facing face 8a is large, and the viscosity of the ink is too low, a fluidity of the ink is relatively high. Thus, the following problem arises during the wiping of the facing face 8a. That is, after the upstream area of the facing face 8a in the moving direction of the facing-face wiper 56b is wiped with the facing-face wiper 56b, the ink having the high water content moved with the facing-face wiper 56b is moved through between contact portions of the facing face 8a and the facing-face wiper 56b due to its fluidity in the movement of the facing-face wiper 56b and left on a relatively wide area of the facing face 8a.

In order to solve this problem, in the present embodiment, the moving direction of the facing-face wiper 56b in the facing-face wiping is the direction directed toward the area of the facing face 8a near the air inlet opening 81a as described above. Thus, it is possible to reduce an amount of the ink moving through between the contact portions of the facing face 8a and the facing-face wiper 56b in the facing-face wiping, making it possible to reduce an amount of the ink remaining on the facing face 8a after the facing-face wiping.

It is noted that the head wiping may also cause a problem in which, if an amount of the water content of the ink on the ejection face 10a is large, the ink having the large amount of water content moved with the ejection-face wiper 56a is moved through between contact portions of the ejection face 10a and the ejection-face wiper 56a due to its fluidity and left on the ejection face 10a. However, in the head wiping, most of the ink wiped with the ejection-face wiper 56a moves downward on the ejection-face wiper 56a and is received on the facing face 8a of the facing member 8, causing less problem than the facing-face wiper 56b. Moreover, an amount of the ink on the ejection face 10a is less than that on the facing face 8a of the facing member 8.

There will be next explained the controller 100 with reference to FIG. 8. The controller 100 includes: a central processing unit (CPU); a read only memory (ROM) rewritably storing programs to be executed by the CPU and data used for these programs; and a random access memory (RAM) for temporarily storing the data in the execution of the programs. The controller 100 includes various functional sections which are constituted by cooperation of these hardware and software in the ROM with each other. As shown in FIG. 8, the controller 100 includes a conveyance control section 141, an image-data storage section 142, a head control section 143, a maintenance control section 144, and a wiping drive control section 145.

The conveyance control section 141 is configured, based on the recording command transmitted from the external device, to control the sheet-supply unit 1c, the guide unit 25, and the conveyor unit 30 to convey the sheet P at a predetermined speed in the conveying direction. The image-data storage section 142 is configured to store the image data contained in the recording command transmitted from the external device. The head control section 143 is configured, based on the image data stored in the image-data storage section 142, to control the head 10 to eject the ink onto the conveyed sheet P in the image recording.

The maintenance control section 144 is configured to control the head 10, the facing-member moving mechanism 96, the head raising and lowering mechanism 50, the platen motor 43, the pump 54, the up/down motor 65, and the humidification pump 83 in the maintenance such as the discharge operation, the wiping operation, and the humidifying operation. The wiping drive control section 145 is configured to control the wiper drive motor 59 in the wiping operation.

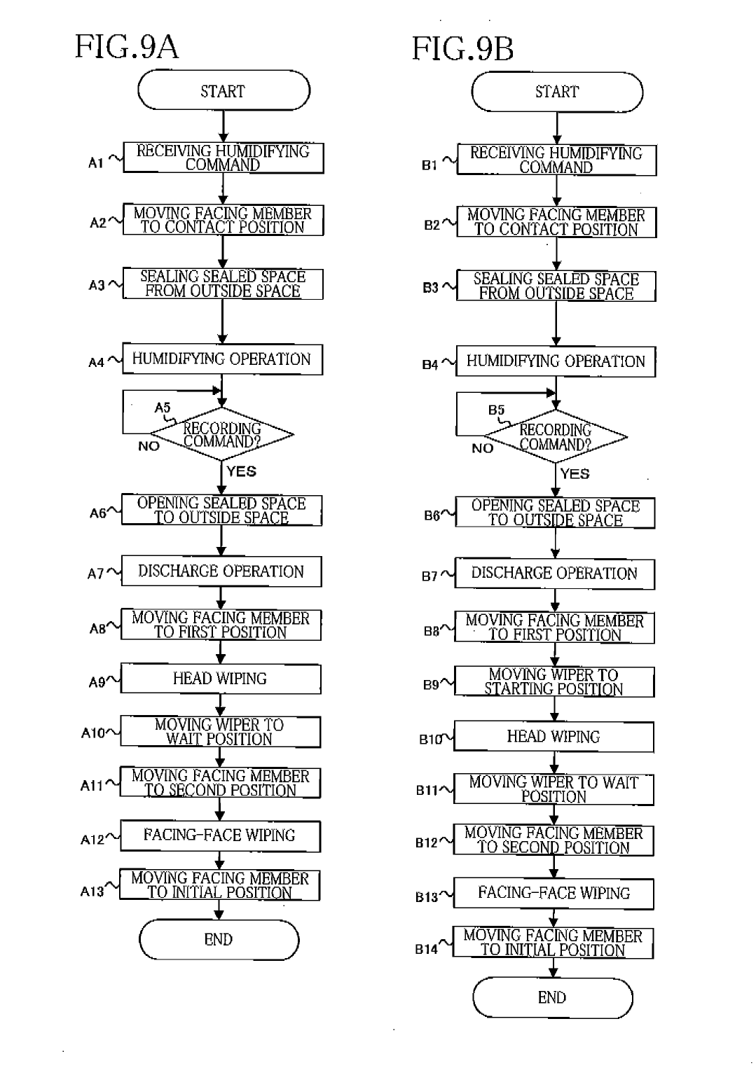

There will be next explained one example of the maintenance controlled by the controller 100 with reference to FIG. 9A. It is noted that a state of the printer 1 at a start of an operation flow in FIG. 9A is a state after the image recording is performed. That is, as shown in FIG. 2A, the facing member 8 is positioned at the initial position, and the platen 40 is positioned at the facing position.

Initially in step A1, the controller 100 receives a humidifying command. Then in step A2, as shown in FIG. 2B, the maintenance control section 144 controls the platen motor 43 to move the platen 40 to the non-facing position and then controls the facing-member moving mechanism 96 to move the facing member 8 to the contact position.

Then in step A3, the maintenance control section 144 controls the up/down motor 65 to move the movable member 63 downward to move the annular member 61 to the capping position at which the distal end 61a is held in contact with the facing face 8a. As a result, the sealed space S1 is sealed or isolated from the outside space S2. Then in step A4, the maintenance control section 144 drives the humidification pump 83 for a predetermined length of time to perform the humidifying operation. As a result, the humid air is supplied from the air inlet opening 81a into the sealed space S1, and the air in the sealed space S1 is discharged from the air outlet opening 81b, so that the sealed space S1 is filled with the humid air. This suppresses an increase in viscosity of the ink near the ejection openings 108. Moreover, it is possible to lower the viscosity of the ink firmly stuck to the ejection face 10a and the facing face 8a.

Then in step A5, the controller 100 judges whether the recording command is received from the external device. When the controller 100 judges that the recording command has not been received (A5: NO), the processing in step A5 is repeated. On the other hand, when the controller 100 judges that the recording command has been received (A5: YES), the maintenance control section 144 in step A6 controls the up/down motor 65 to move the movable member 63 upward to move the annular member 61 to the distant position at which the distal end 61a of the annular member 61 is distant from the facing face 8a. As a result, the sealed space S1 is open to the outside space S2.

Then in step A7, the maintenance control section 144 drives the actuators of the head 10 to discharge the ink from all the ejection openings 108 of the head 10 toward the facing member 8. As a result, it is possible to discharge the ink whose density has been lowered at the meniscuses by the humidifying operation. The ink discharged in the flushing is to be landed on the facing member 8 which never contacts the sheet P in the image recording. Thus, the sheet P is not stained with the discharged ink.

Then in step A8, the maintenance control section 144 controls the facing-member moving mechanism 96 to move the facing member 8 to the first position and controls the head raising and lowering mechanism 50 to move the head 10 to the head wiping position. Then in step A9, the head wiping is performed in which the wiping drive control section 145 controls the wiper drive motor 59 to move the base portion 56c rightward from its wait position to cause the parallel movement of the ejection-face wiper 56a with respect to the ejection face 10a in the state in which the ejection-face wiper 56a is held in contact with the ejection face 10a. As a result, the ink is wiped from the ejection face 10a. Further, the moving direction of the ejection-face wiper 56a in the head wiping is the direction directed toward the area of the ejection face 10a on which the larger amount of the condensation is formed. Thus, it is possible to prevent the water of the condensation formed on the ejection face 10a from flowing into the meniscuses of the ink formed in the ejection openings 108, thereby preventing the lowering of the ink density of the meniscuses. It is noted that, most of the ink wiped with the ejection-face wiper 56a in the head wiping moves downward and is received on the facing member 8.

Then in step A10, the maintenance control section 144 controls the head raising and lowering mechanism 50 to move the head 10 to the facing-face wiping position, and then the wiping drive control section 145 controls the wiper drive motor 59 to move the base portion 56c leftward in FIGS. 3A-3C to the wait position. It is noted that, when the base portion 56c is moved leftward in step A10, the head 10 is positioned at the facing-face wiping position, and accordingly the ejection-face wiper 56a is moved without contacting the ejection face 10a.

Then in step A11, the maintenance control section 144 controls the facing-member moving mechanism 96 to move the facing member 8 to the second position. Then in step A12, the facing-face wiping is performed in which the wiping drive control section 145 controls the wiper drive motor 59 to move the base portion 56c rightward from its wait position to cause the parallel movement of the facing-face wiper 56b with respect to the facing face 8a in the state in which the facing-face wiper 56b is held in contact with the facing face 8a. As a result, the ink is wiped from the facing face 8a. Further, the moving direction of the facing-face wiper 56b in the facing-face wiping is the direction directed toward the area of the facing face 8a near the air inlet opening 81a. Thus, it is possible to reduce the amount of the ink moving through between the contact portions of the facing face 8a and the facing-face wiper 56b in the facing-face wiping, making it possible to reduce the amount of the ink remaining on the facing face 8a after the facing-face wiping.

Then in step A13, the maintenance control section 144 controls the facing-member moving mechanism 96 to move the facing member 8 to the initial position, and then the wiping drive control section 145 controls the wiper drive motor 59 to move the base portion 56c back to its wait position, and the maintenance control section 144 controls the platen motor 43 to move the platen 40 back to the facing position. It is noted that, when the base portion 56c is moved leftward in step A13, the facing member 8 is positioned at the initial position, and accordingly the facing-face wiper 56b is moved without contacting the facing-face wiper 56b. The maintenance by the controller 100 is thus finished, and the image recording is performed based on the recording command received in step A5.

As described above, in the printer 1 as the present embodiment, the air inlet opening 81a is provided at the downstream end of the moving path of the ejection-face wiper 56a in the head wiping. As a result, the moving direction of the ejection-face wiper 56a in the head wiping is the direction directed toward the area of the ejection face 10a on which the larger amount of the condensation is formed. Thus, it is possible to prevent the water of the condensation formed on the ejection face 10a from flowing into the meniscuses of the ink formed in the ejection openings 108, thereby preventing the lowering of the ink density of the meniscuses.

Further, in the printer 1 as the present embodiment, the moving direction of the facing-face wiper 56b in the facing-face wiping coincides with the direction directed toward the area of the facing face 8a near the air inlet opening 81a. Thus, it is possible to reduce the amount of the ink moving through between the contact portions of the facing face 8a and the facing-face wiper 56b in the facing-face wiping, making it possible to reduce the amount of the ink remaining on the facing face 8a after the facing-face wiping.

Further, in the printer 1 as the present embodiment, the facing-face wiping is performed after the head wiping. As a result, even if the ink wiped with the ejection-face wiper 56a has been moved onto the facing face 8a of the facing member 8 in the head wiping, the ink is removed by the facing-face wiping. Thus, all the ink can be reliably wiped from the ejection face 10a and the facing member 8.

### Second Embodiment

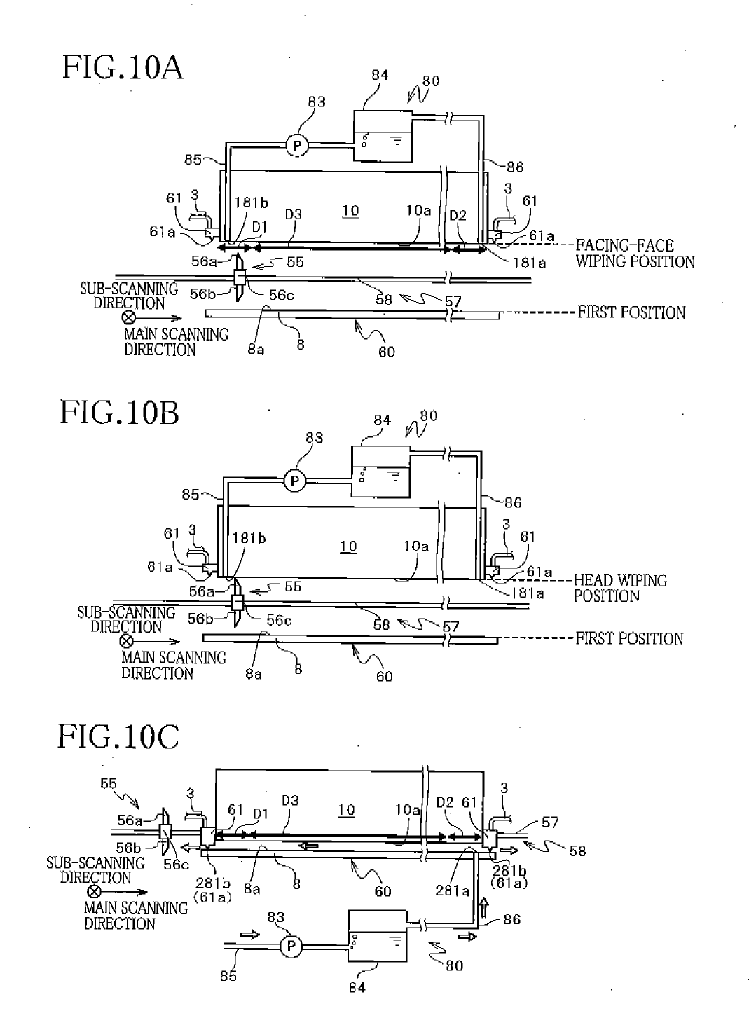

There will be next explained a second embodiment of the present invention with reference to FIGS. 9B, 10A, and 10B. The second embodiment is different from the first embodiment in the following point. That is, in the first embodiment, the air inlet opening 81a and the air outlet opening 81b are respectively formed in the pair of joints 81 between which the head 10 is interposed in the main scanning direction, while, in the second embodiment, an air inlet opening 181a and an air outlet opening 181b are formed in the ejection face 10a. In the following description, the same reference numerals as used in the first embodiment are used to designate the corresponding elements of the second embodiment, and an explanation of which is dispensed with.

In the present embodiment, as shown in FIG. 10A, the air inlet opening 181a is formed in the no-ejection-opening formed area D2 of the ejection face 10a, and the air outlet opening 181b is formed in the no-ejection-opening formed area D1 of the ejection face 10a.

There will be next explained one example of the maintenance controlled by the controller 100 in the present embodiment with reference to FIG. 9B.

Steps B1-B7 are generally the same as steps A1-A7 in the first embodiment which have been explained above with reference to FIG. 9A, and an explanation of steps B1-B7 is omitted.

In step B8, the maintenance control section 144 controls the facing-member moving mechanism 96 to move the facing member 8 to the first position and controls the head raising and lowering mechanism 50 to move the head 10 to the facing-face wiping position. Then in step B9, the wiping drive control section 145 controls the wiper drive motor 59 to move the base portion 56c rightward in FIGS. 10A and 10B such that the ejection-face wiper 56a is positioned at a starting position of the head wiping. Here, as shown in FIG. 10B, the starting position of the head wiping is located in the no-ejection-opening formed area D1 at a position at which a position of the ejection-face wiper 56a in the main scanning direction is located downstream of the air outlet opening 181b in the direction directed from the no-ejection-opening formed area D1 toward the no-ejection-opening formed area D2.

Then in step B10, the maintenance control section 144 controls the head raising and lowering mechanism 50 to move the head 10 to the head wiping position, and then the head wiping is performed in which the wiping drive control section 145 controls the wiper drive motor 59 to move the base portion 56c rightward from the starting position of the head wiping so as to cause the parallel movement of the ejection-face wiper 56a with respect to the ejection face 10a in the state in which the ejection-face wiper 56a is held in contact with the ejection face 10a. Here, if foreign matters such as paper dust enter into the air outlet opening 181b, the foreign matters may be transferred into the humidification pump 83 or the tank 84 through the tube 85 upon the discharge of the air in the sealed space S1 in the humidifying operation, lowering a humidification performance of the humid-air supply/discharge mechanism 80. In the present embodiment, however, the head wiping is started from the position downstream of the air outlet opening 181b in the direction directed from the no-ejection-opening formed area D1 toward the no-ejection-opening formed area D2 as described above. Thus, it is possible to prevent the foreign matters on the ejection face 10a from entering into the air outlet opening 181b.

Steps B11-B14 are generally the same as steps A10-A13 in the first embodiment which have been explained above with reference to FIG. 9A, and an explanation of steps B11-B14 is omitted. It is noted that, in the second embodiment, an end position of the head wiping may be defined by moving the ejection-face wiper 56a off the ejection face 10a when the ejection-face wiper 56a is moved to the no-ejection-opening formed area D2 in the main scanning direction.

### Third Embodiment

There will be next explained a third embodiment of the present invention with reference to FIG. 10C. The third embodiment is different from the first embodiment in the following points. That is, in the first embodiment, the air inlet opening 81a and the air outlet opening 81b are respectively formed in the pair of joints 81 between which the head 10 is interposed in the main scanning direction, while, in the third embodiment, an air inlet opening 281a is formed in the facing face 8a, and each of air outlet openings 281b is a space formed between the facing face 8a and the distal end 61a of the annular member 61. Further, in the first embodiment, the air is circulated in the humidifying operation such that the air in the sealed space S1 discharged from the air outlet opening 81b is collected by the humidification pump 83 and the tank 84, but in the third embodiment, the air is not circulated. In the following description, the same reference numerals as used in the first embodiment are used to designate the corresponding elements of the third embodiment, and an explanation of which is dispensed with.

As shown in FIG. 10C, in the present embodiment, one end of the tube 85 communicates with the outside space S2. The air inlet opening 281a is formed in the facing face 8a just under the no-ejection-opening formed area D2, in other words, the air inlet opening 281a is formed at an area facing the no-ejection-opening formed area D2. The air inlet opening 281a is formed at the downstream end of the moving path of the ejection-face wiper 56a in the head wiping.

When the humidifying operation is performed in the present embodiment, the controller 100 drives the up/down motor 65 to move the annular member 61 to the capping position so as to establish the sealing state of the sealed space S1. The controller 100 then drives the humidification pump 83 to flow the air in the tank 84 along white arrows shown in FIG. 00C. That is, the humid air in the upper space of the tank 84 flows from the tank 84 toward the air inlet opening 281a, so that the sealed space S1 is filled with the humid air. In this operation, a negative pressure is generated in the tank 84, whereby the air in the outside space S2 is collected through the tube 85 and flows toward the tank 84. When the air in the tank 84 is continuously supplied into the sealed space S1, the sealed space S1 is pressurized. When a pressure in the sealed space S1 becomes equal to or higher than a specific value, the spaces (i.e., the air outlet openings 281b) are formed between contact portions of the facing face 8a and the distal end 61a of the annular member 61, so that the air in the sealed space S1 is discharged from the spaces (the air outlet openings 281b). This humidifying operation suppresses the increase in the viscosity of the ink near all the ejection openings 108. Further, since the air inlet opening 281a is provided at the downstream end of the moving path of the ejection-face wiper 56a in the head wiping, the moving direction of the ejection-face wiper 56a in the head wiping coincides with the direction directed toward the area of the ejection face 10a on which the larger amount of the condensation is formed. This makes it possible to prevent the water of the condensation formed on the ejection face 10a from flowing into the meniscuses of the ink formed in the ejection openings 108, thereby preventing the lowering of the ink density of the meniscuses.

While the embodiments of the present invention have been described above, it is to be understood that the invention is not limited to the details of the illustrated embodiments, but may be embodied with various changes and modifications, which may occur to those skilled in the art, without departing from the spirit and scope of the invention. For example, in the above-described embodiments, the distal end 61a of the annular member 61 is movable upward and downward, but the present invention is not limited to this configuration. For example, the printer 1 may be configured such that the distal end 61a of the annular member 61 is fixed to the head holder 3 so as not to be movable, and the position of the distal end 61a of the annular member 61 relative to the ejection face 10a is constant. This configuration may be employed as long as the distal end 61a of the annular member 61 is held in contact with the facing member 8 when the facing member 8 is positioned at the contact position. Further, the printer 1 may be configured such that the annular member 61 is provided on the facing member 8, and the head 10 does not include the capping mechanism.

Further, in the above-described embodiments, the maintenance control section 144 is configured to execute the controls such that the flushing is performed after the humidifying operation, but the purging may be performed after the humidifying operation. Further, in the above-described embodiments, the head wiping and the facing-face wiping are performed after the flushing, but only the head wiping may be performed after the flushing. Further, as described above, the maintenance control section 144 is configured to execute the control such that the flushing is performed after the humidifying operation and before the wiping operation, but the controller 100 may be configured to control the wiper unit 55 to perform at least one of the head wiping and the facing-face wiping without the maintenance controlled by the maintenance control section 144 after the humidifying operation.

Further, a shape and a position of the air inlet opening are not limited in particular as long as the air inlet opening is provided at the downstream end of the moving path of the ejection-face wiper 56a in the head wiping. Further, a shape and a position of the air outlet opening are not limited in particular as long as the air outlet opening faces or contacts the sealed space S1. For example, the printer 1 may be configured such that the air inlet opening is formed in the no-ejection-opening formed area D2 of the ejection face 10a, and the air outlet opening is formed in one of the joints 81 of the head holder 3.

The present invention is applicable to any of line and serial printers and applicable not only to the printer but also to other devices such as a facsimile machine and a copying machine. The present invention is also applicable to a liquid ejection apparatus configured to eject liquid other than the ink to perform recording. The recording medium is not limited to the sheet P, and various recoding media may be used. Further, the present invention is applicable regardless of a type of the ink ejection.

What is claimed is:

1. A liquid ejection apparatus, comprising:
a liquid ejection head having an ejection face that has a plurality of ejection openings for ejecting liquid, an ejection space being defined facing the ejection face;
a sealing mechanism configured to selectively establish one of (i) a sealing state in which a sealed space including the ejection space is sealed from an outside thereof and (ii) an open state in which the sealed space is open to the outside;
an air inlet opening through which an air is introduced into the sealed space in the sealing state;
an air outlet opening through which an air is discharged from the sealed space in the sealing state;
a humid-air supply/discharge mechanism configured, when the sealing mechanism is in the sealing state, to supply a humid air into the sealed space via the air inlet opening and discharge the air from the sealed space via the air outlet opening;
an ejection-face wiper configured to wipe the ejection face; and
a control device configured to control the ejection-face wiper to perform the wiping of the liquid from the ejection face by causing parallel movement of the ejection-face wiper with respect to the ejection face in a wiper moving direction directed from a first end area of the ejection face toward a second end area thereof in a state in which the ejection-face wiper is held in contact with the ejection face,
wherein the air inlet opening is provided at a position nearer to a downstream end of a moving path of the ejection-face wiper moved by the control device than to an upstream end of the moving path in the wiper moving direction.

2. The liquid ejection apparatus according to claim 1,
wherein the plurality of ejection openings are formed in an ejection-opening formed area of the ejection face,
wherein the first end area is located upstream of the ejection-opening formed area in the wiper moving direction, and
wherein the second end area is located downstream of the ejection-opening formed area in the wiper moving direction.

3. The liquid ejection apparatus according to claim 1,
wherein the air inlet opening is provided downstream of all the plurality of ejection openings in the wiper moving direction, and
wherein the air outlet opening is provided upstream of all the plurality of ejection openings in the wiper moving direction.

4. The liquid ejection apparatus according to claim 3, wherein the air inlet opening and the air outlet opening are formed in the ejection face.

5. The liquid ejection apparatus according to claim 4, wherein the control device is configured to control the ejection-face wiper to start the wiping from a position located downstream of the air outlet opening in the wiper moving direction as a starting position of the wiping.

6. The liquid ejection apparatus according to claim 1, wherein the sealing mechanism includes:
a facing member facing the ejection face; and
an annular member disposed around the liquid ejection head and contactable with the facing member to establish the sealing state with the ejection face and the facing member.

7. The liquid ejection apparatus according to claim 6, further comprising:
a facing-face wiper configured to wipe the liquid from a facing face of the facing member, the facing face facing the ejection face,
wherein the control device is configured to control the liquid ejection head to discharge the liquid from the ejection openings toward the facing member and is configured to control the facing-face wiper to perform the wiping of the liquid from the facing face by causing parallel movement of the facing-face wiper with respect to the facing face in the wiper moving direction in a state in which the facing-face wiper is held in contact with the facing face.

8. The liquid ejection apparatus according to claim 1, wherein the control device is configured to control the liquid ejection head to discharge the liquid from the ejection openings toward the facing member and is configured to control the ejection-face wiper to perform the wiping of the liquid from the ejection face after the liquid is discharged.

9. The liquid ejection apparatus according to claim 7, wherein the control device is configured to control the facing-face wiper to perform the wiping of the liquid from the facing face after the liquid is discharged.

10. The liquid ejection apparatus according to claim 7, wherein the control device is configured, when the liquid is discharged, to:
control the ejection-face wiper to perform the wiping of the liquid from the ejection face by causing the parallel movement of the ejection-face wiper with respect to the ejection face in the wiper moving direction in the state in which the ejection-face wiper is held in contact with the ejection face; and thereafter
control the facing-face wiper to perform the wiping of the liquid from the facing face by causing the parallel movement of the facing-face wiper with respect to the facing face in the wiper moving direction in the state in which the facing-face wiper is held in contact with the facing face.

11. The liquid ejection apparatus according to claim 1, wherein the control device is configured to move the ejection-face wiper such that a position in the first end area is a starting position of the wiping by the ejection-face wiper and such that a position in the second end area is an end position of the wiping by the ejection-face wiper.

12. A wiping method for wiping an ejection face of a liquid ejection apparatus, the ejection face having a plurality of ejection openings for ejecting liquid, an ejection space being defined facing the ejection face, the liquid ejection apparatus comprising: a sealing mechanism configured to selectively establish one of (i) a sealing state in which a sealed space including the ejection space is sealed from an outside thereof and (ii) an open state in which the sealed space is open to the outside; an air inlet opening through which an air is introduced into the sealed space in the sealing state; an air outlet opening through which an air is discharged from the sealed space in the sealing state; a humid-air supply/discharge mechanism configured, when the sealing mechanism is in the sealing state, to supply a humid air into the sealed space via the air inlet opening and discharge the air from the sealed space via the air outlet opening; and an ejection-face wiper configured to wipe the liquid from the ejection face, the wiping method comprising:
wiping the liquid from the ejection face by causing parallel movement of the ejection-face wiper with respect to the ejection face in a direction directed toward the air inlet opening in a state in which the ejection-face wiper is held in contact with the ejection face,
wherein the air inlet opening is provided at a position nearer to a downstream end of a moving path of the moved ejection-face wiper than to an upstream end of the moving path in the wiper moving direction.
